(19) United States
(12) Patent Application Publication
(10) Pub. No.: US 2005/0174895 A1
(43) Pub. Date: Aug. 11, 2005

(54) Method of copy detection and protection using time jumps

(76) Inventors: Petrus Henricus Cornelius Bentvelsen, Eindhoven (NL); Paulus Franciscus Vollebregt, 's-Gravenhagen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/511,213

(22) PCT Filed: Apr. 1, 2003
(86) PCT No.: PCT/IB03/01365

(30) Foreign Application Priority Data
Apr. 18, 2002 (EP) 02076517.8

(51) Int. Cl. G11B 7/085; G11B 5/09

(52) U.S. Cl. 369/30.05; 369/53.21; 369/47.19

(57) ABSTRACT

The invention relates to a method of copy detection of a record carrier wherein time stamps are assigned to information blocks stored on said record carrier. In order to provide a secure method for distinguishing between an original and a copy it is proposed according to the present invention that the timing of said time stamps assigned to subsequent information blocks comprises at least one discontinuity and that said at least one discontinuity is used to encode user information.

The invention relates to a method of copy detection of a record carrier wherein time stamps are assigned to information blocks stored on said record carrier. The invention relates further to a method of read-out of such a record carrier, to corresponding apparatuses, to such a record carrier itself and to a computer program for implementing said methods.

WO 98/03973 A2 discloses an optical disc and an optical disc recording apparatus which provide protection against undesired or illegal copying. While address labels assigned to sectors of the optical disc generally increase linearly, the address labels of specific sectors, which may have an informationless content, are given, e.g. zero, address values in order to prevent copying CD-ROM discs on a standard CD recorder apparatus.

It is often desired to distinguish between an original and a copied record carrier in an easy way. Therefore, often a unique identifier is assigned to and stored on a record carrier, e.g. by a distributor or a sales point of said record carrier. It is therefore an object of the present invention to provide a method of copy detection and protection of a record carrier which allows a replay device to distinguish between an original and a copy of a record carrier with high reliability. Further, a corresponding method of read-out of such a record carrier shall be provided.

This object is achieved according to the present invention by a method as claimed in claim 1 according to which the timing of the time stamps assigned to subsequent information blocks comprises at least one discontinuity and wherein said at least one discontinuity is used to encode user information. Said discontinuity is designed such that a replay device can read said record carrier. However, when copying such a record carrier, e.g. to a R/RW disc, such discontinuities will be corrected so that the copy will have a continuous timing. Thus, the presence of discontinuities in the timing of the time stamps can be used as an indication if the record carrier is an original or a copy. Further, user information is encoded by use of said at least one discontinuity. For instance, a secure unique identifier can be encoded. If any discontinuities in the timing of the time stamps are corrected on a copy which correction is usually done by a recording device such a secure unique identifier can then not be decoded by a read-out device when accessing such a copy.

Preferred embodiments of the invention are defined in the dependent claims. A method of read-out of a record carrier is defined in claim 6, comprising the steps of:

reading said time stamps from said record carrier, and

decoding said time stamps to obtain said user information encoded therein.

A corresponding apparatus for a copy detection and an apparatus for read-out of a record carrier are defined in claims 7 and 8. A record carrier according to the present invention is defined in claim 9. The invention still further relates to a computer program for implementing the methods according to the present invention as claimed in claim 10.

The invention will now be explained more in detail with reference to the Figures, in which:

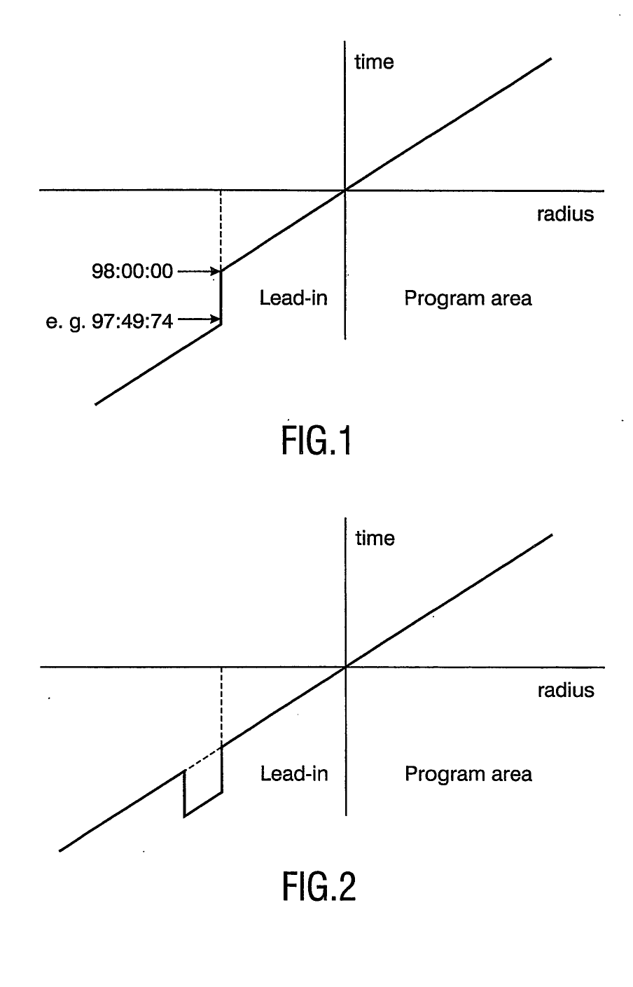

FIG. 1 shows a first possibility of a discontinuity,

FIG. 2 shows a second possibility of a discontinuity,

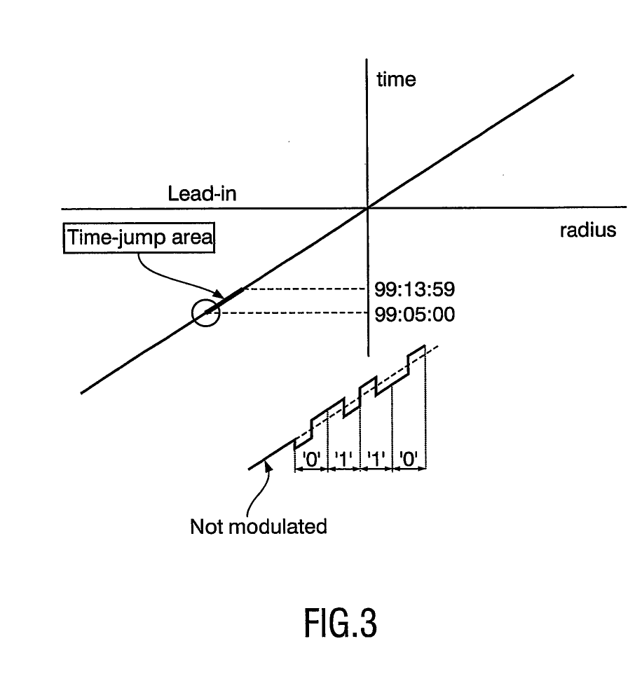

FIG. 3 shows a third possibility of a discontinuity,

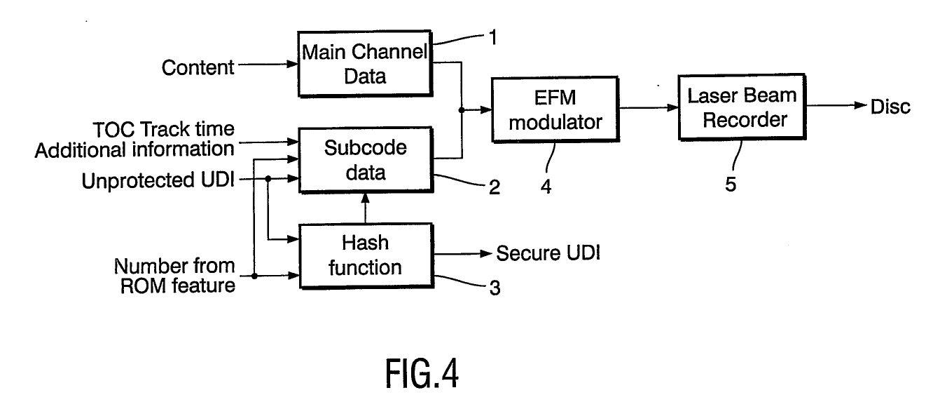

FIG. 4 shows a block diagram of an encoder according to the invention, and

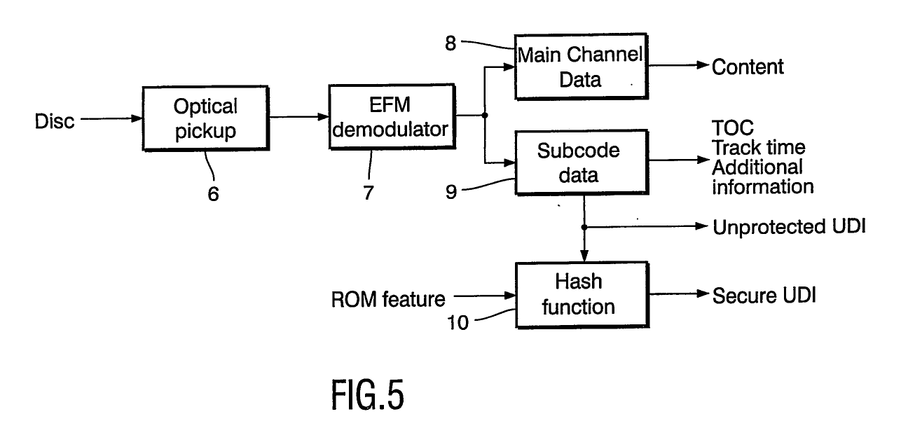

FIG. 5 shows a block diagram of a decoder according to the invention.

FIG. 1 shows a first possibility of providing a discontinuity in the timing of time stamps assigned to information blocks stored on a record carrier such as an optical disc. Usually, the timing is continuous, i.e. time stamps assigned to subsequent information blocks are continuous and increase linearly. However, according to said embodiment of the invention, on a fixed location in the lead-in area of the record carrier, the subcode timing has a jump in time. In the shown example the subcode frame 97:49:74 is followed by a subcode frame 98:00:00, i.e. there is a time jump in the subcode timing. While this is a simple example, every title can have a different jump length.

Another simple possibility of a discontinuity is shown in FIG. 2 where in the lead-in area the subcode time is first decreased and thereafter, after a linearly increasing portion, increased by a jump in time back to the original linearly increasing timing line.

A read-out device accessing a record carrier having such discontinuities can, after a firmware change, at least detect such discontinuities or even measure the length of the time jump. This means that user information can be encoded into said discontinuities, e.g. into the way, length and/or positions of time jumps.

A third possibility of providing discontinuities in a certain time-jump area in the lead-in area of a disc is shown in FIG. 3. Therein, the timing is modulated in order to encode a bit sequence “0110”. As shown, a sequence of a negative time jump followed by a positive time jump, “negative” meaning a decrease in time and “positive” meaning an increase in time, shall be interpreted as a bit having value zero, while a time jump sequence of a positive time jump followed by a negative time jump shall be interpreted as bit having value one. In this way a particular user information can be encoded into discontinuities of the timing.

A block diagram of an encoder according to the present invention is shown in FIG. 4. Therein content is encoded into main channel data by a main channel data unit 1, and additional information such as table of content information and track-timing information is encoded into subcode data by a subcode data unit 2. Further, an unprotected UDI (Unique Disc Identifier) uniquely identifying the disc on which said data shall be stored is embedded in said subcode data. It should be noted, that, generally, a UDI can be stored anywhere, i.e. in main channel data or subcode data.

A hash function unit 3 is provided according to the present invention to generate a secure UDI if a particular application or replay device requires a high certainty that the UDI originates from a read-only disc, but not from a copy. Said hash function unit 3 has as inputs the unprotected UDI and, in the particular example shown in FIG. 4, a number generated from a ROM feature. Such a ROM feature could be the way in which the timing is modulated to embed discontinuities in the timing as shown in FIGS. 1 to 3. The output of the hash function unit 3 is a secure UDI. Said ROM feature is also provided to the subcode data unit 2 in order to modulate the timing so as to insert such discontinuities which can then be used by a read-out device for generating said secure UDI.

An EFM modulator 4 is further provided for interleaving and modulating the main channel data and the subcode data into a channel bit stream which is finally recorded on a disc by a laser beam recorder 5.

FIG. 5 shows a block diagram of a decoder according to the present invention which is adapted for detection if the accessed disc is an original or a copy. Therein an optical pick-up unit 6 is provided for accessing and reading a disc. The read channel bit stream is demodulated by an EFM demodulator 7 into main channel data processed by a main channel data unit 8 into the actual content and into subcode data processed by a subcode data unit 9. From said subcode data the unprotected UDI can be retrieved. Said unprotected UDI is also provided to a hash function unit 10 which is similar or identical to the hash function unit 3 of the encoder. As second input the described ROM feature detected from the accessed disc is provided to the hash function unit 10, i.e. any discontinuities of the timing, in particular of the subcode data and/or in the lead-in area, which, together with the unprotected UDI, allow the calculation of the secure UDI. If no discontinuities can be detected, as will be the case for a copied disc, the secure UDI can not be generated. Thus, an efficient and secure method of distinguishing between an original and a copy is provided according to the present invention.

1. Method of copy detection of a record carrier wherein time stamps are assigned to information blocks stored on said record carrier, characterized in that the timing of said time stamps assigned to subsequent information blocks comprises at least one discontinuity and that said at least one discontinuity is used to encode user information.

2. Method according to claim 1, wherein said at least one discontinuity is used to encode a unique identifier uniquely identifying said record carrier.

3. Method according to claim 2, wherein said unique identifier is stored in the subcode Q-channel, particularly of an optical recording system for read-only optical discs.

4. Method according to claim 1, wherein said at least one discontinuity only appears at predetermined positions in the lead-in area lead-out area and/or program area of an optical record carrier.

5. Method according to claim 1, wherein different types of discontinuities are applied for different pieces of content stored on a record carrier.

6. Method of read-out of a record carrier wherein time stamps are assigned to information blocks stored on said record carrier such that the timing of said time stamps assigned to subsequent information blocks comprises at least one discontinuity and that said at least one discontinuity is used to encode user information, comprising the steps of:
reading said time stamps from said record carrier, and
decoding said time stamps to obtain said user information encoded therein.

7. Apparatus for copy detection of a record carrier wherein time stamps are assigned to information blocks stored on said record carrier, characterized by means for assigning said time stamps to subsequent information blocks such that the timing of said time stamps comprises at least one discontinuity and by means for encoding user information into said at least one discontinuity.

8. Apparatus for read-out of a record carrier wherein time stamps are assigned to information blocks stored on said record carrier such that the timing of said time stamps assigned to subsequent information blocks comprises at least one discontinuity and that said at least one discontinuity is used to encode user information, comprising:
means for reading said time stamps from said record carrier, and
means for decoding said time stamps to obtain said user information encoded therein.

9. Record carrier wherein time stamps or assigned to information blocks stored on said record carrier, characterized in that the timing of said time stamps assigned to subsequent information blocks comprises at least one discontinuity and that into said at least one discontinuity is user information is encoded.

10. Computer program for implementing the method of claim 1 comprising program code means for causing a computer to perform the steps of the method as claimed in claim 1 when said computer program is run on a computer.
